(19) United States
(12) Patent Application Publication
(10) Pub. No.: US 2005/0024603 A1
(43) Pub. Date: Feb. 3, 2005

(54) PROJECTION LENS SET SHIFTING APPARATUS

(76) Inventors: Chih-Chung YANG, Miao-Li County (TW); Ching-Chi LIN, Miao-Li County (TW); Rolls HUNG, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,473

(22) Filed: Jul. 14, 2004

(30) Foreign Application Priority Data
Jul. 15, 2003 (TW) 092212996

(51) Int. Cl. G03B 21/14; H04N 5/74

(52) U.S. Cl. 353/100

(57) ABSTRACT

A projection lens set shifting apparatus includes a gear train, adjusting shaft and projection lens set, wherein an eccentric wheel is fixed on an output shaft of the gear train and a notch is opened at the circumference of the eccentric wheel. An eccentric pin is fixed at one end of the adjusting shaft. The eccentric pin in the notch connects the adjusting shaft and the gear train. The projection lens set is moved up and down along the adjusting shaft by rotating the gear train to drive the adjusting shaft, thus cause an image focusing location to be moved with the projection lens set and shifted up and down on a screen. Therefore, an image projection location can be changed and the image deformation is not yielded. Besides, a gap between the notch and the eccentric pin absorbs a production tolerance.

### BACKGROUND OF INVENTION

1. Field of the Invention

The present invention relates to a shifting apparatus, and more particularly to a non-coaxial projection lens set shifting apparatus for adjusting the upward and downward movement of a projection lens set.

2. Description of the Prior Art

A projector is usually placed on a table or hung up on a ceiling and an image is projected onto a screen through a projection lens set thereof. But, the projector must be adjusted to allow the image to be projected onto a proper location on the screen to adapt to the different location and size of the screen.

Please refer to FIG. 1. Taking a projector 10 placed on a table 1 as an example, a way for adjusting the projector 10 is to screw elevating legs 12 at the bottom of the projector 10 under the end of a projecting lens set (not shown in the figure) for allowing an image ejected from the projection lens set to be projected on a screen 2 obliquely by rotating the elevating legs 12 to cause an inclined angle formed between the projector 10 and the table 1 to attain to the adjustment of the location that the image is projected on the screen 2. However, the way mentioned above causes the projection lens set to project the image obliquely on the screen 2, the distance of the optical path at the upper side of the screen is longer than the lower side thereof so that the image is deformed as a trapezoid shape on the screen 2 to influence sight amusement. Therefore, how to adjust the projection location of the image and not to yield the image deformation and how to simplify the adjustment structure and reduce difficulty in the assembly so as to lower the production cost are the major topics of the research and development in the industry.

### SUMMARY OF INVENTION

One object of the present invention is to provide a projection lens set shifting apparatus, enabling a projection lens set to move parallel to a screen so as to allow an image focusing location to move with the projection lens set and shift up and down on the screen. Therefore, the change of the image projecting location can be attained to and the deformation of the image is not yielded.

Another object of the present invention is to provide a projection lens set shifting apparatus; the matching of a notch and eccentric pin is used to drive an adjusting shaft so as to eliminate the assembly tolerance, reduce the difficulty in the assembly and enhance the production efficiency.

Still another object of the present invention is to provide a projection lens set shifting apparatus; a fine adjustment lens set can be obtain by disposing the lens set properly and connecting it to an adjusting shaft of a projection lens set.

Still another object of the present invention is to provide a projection lens set shifting apparatus; an energy saving and easy rotating adjustment effect can be attained to by adjusting the gear ratio of a gear train properly.

Still another object of the present invention is to provide a projection lens set shifting apparatus; an adjusting shaft is driven by a non-coaxial way so as to be allowed to match with an arbitrary disposition location of a rotating shaft designed in a projection apparatus.

For attaining to the object mentioned above, a projection lens set shifting apparatus according to the present invention comprises a gear train, adjusting shaft and projection lens set, in which an eccentric wheel is fixed on an output shaft of the gear train and a notch is opened at the circumference of the eccentric wheel. An eccentric pin is fixed at one end of the adjusting shaft. The adjusting shaft and the gear train are allowed to connect together by accepting the eccentric pin in the notch. After the projection lens set is screwed to the adjusting shaft through a sliding seat, the projection lens set is moved up and down along the adjusting shaft by rotating the gear train to drive the adjusting shaft so as to cause an image focusing location to be moved with the projection lens set and shifted up and down on a screen. Therefore, an image projection location can be changed and the image deformation is not yielded. Besides, a gap is between the notch and the eccentric pin so as to absorb a production tolerance.

### BRIEF DESCRIPTION OF DRAWINGS

The present invention can be more fully understood by reference to the following description and accompanying drawings, in which:

FIG. 1 is a schematic view, showing a location relationship between a conventional projector and a screen;

FIGS. 2B and 2C are schematic view, showing optical projections of a projection apparatus according to the present invention;

FIG. 3 is a perspective view, showing a projection lens set shifting apparatus of a preferred embodiment according to the present invention;

FIG. 4 is an explosive view, showing a gear train of a projection lens set shifting apparatus of a preferred embodiment according to the present invention;

FIG. 5 is an explosive view, showing a projection lens set of a preferred embodiment according to the present invention; and

FIG. 6 is a perspective view, showing a combination of a projection lens set shifting apparatus and a projection apparatus according to the present invention.

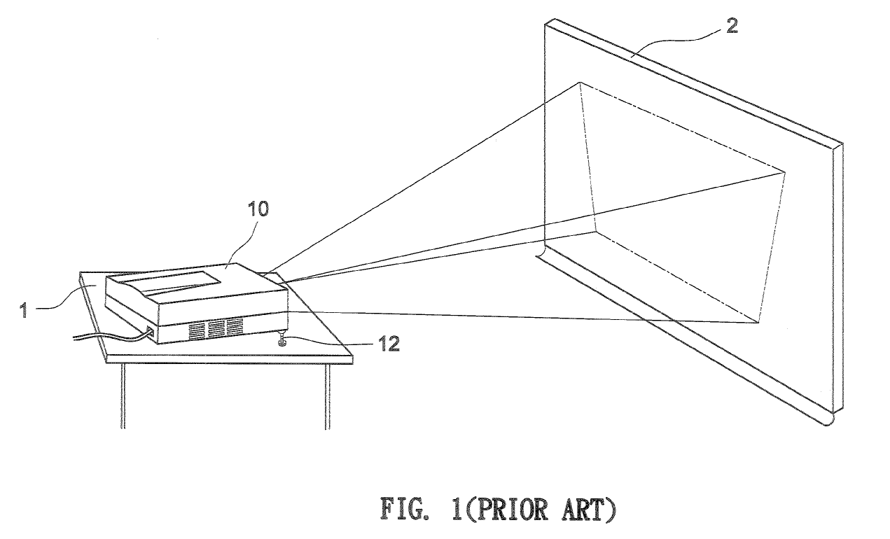

### DETAILED DESCRIPTION

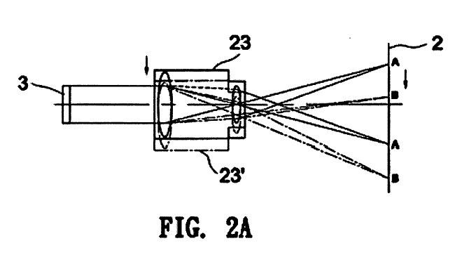

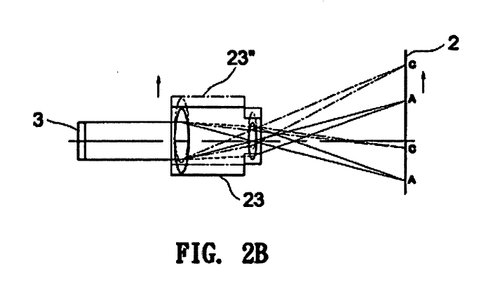

Please refer to FIGS. 2A and 2B. A projection lens set shifting apparatus is installed on a projection lens set 23 of a projection apparatus. When a light valve 3 and the projection lens set 23 are at a same axis, an image is formed at a location A-A on a screen 2 through the projection lens set 23. Please refer to the dotted lines in FIG. 2A. When a projection lens set 23 is moved downward, an image light emitted from the light valve 3 is projected into the projection lens set 23 to form an image at a location B-B on the screen 2 through the projection lens set 23 and to cause the formed image to be shifted downward. As FIG. 2B shows, when a projection lens set 23″ is moved upward, an image light emitted from the light valve 3 is projected into the projection lens set 23″ to form an image at a location C-C on the screen 2 through the projection lens set 23″ and to cause the formed image to be shifted upward. Therefore, the image projected into the light valve 3 shifts up and down with the projection 23 to allow the location of the formed image to shift up and down on the screen 2 by moving the projection lens set 23 parallel to the screen 2 so that the change of the projection location of the image can be practiced without yielding an image deformation.

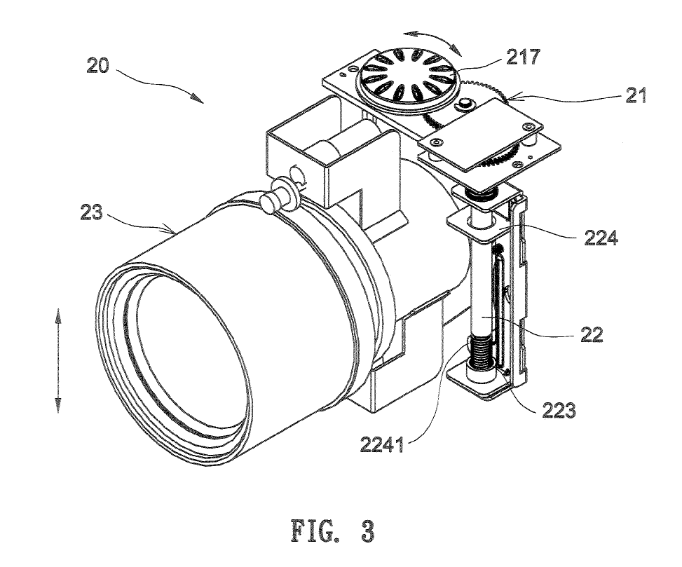

A projection lens set shifting apparatus 20 is used to shift the projection lens set 23 up and down according to the present invention. Please refer to FIG. 3. The projection lens set shifting apparatus 20 comprises a gear train 21 and an adjusting shaft 22, in which the gear train 21 is connected to the adjusting shaft 22. After the projection lens set 23 of a projection apparatus is connected to the adjusting shaft 22, the adjusting shaft 22 is driven by rotating the gear train 21 to attain to the situation that the projection lens set 23 can be shift up and down at a direction parallel to a screen (not shown in the figure).

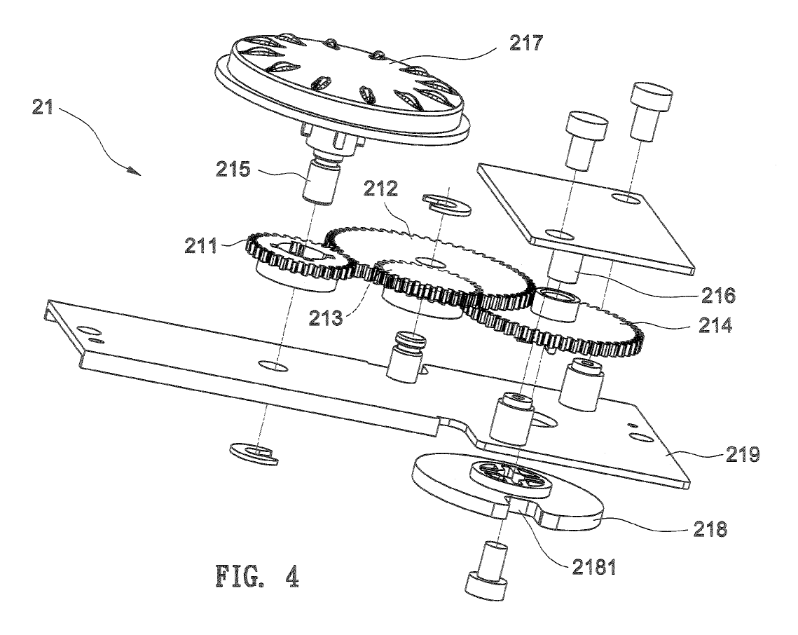

Please refer to FIG. 4. The gear train 21 is made by a plurality of spur gears to form a reduction gear train. The gear train 21 according to the present invention is composed of four gears (i.e. first gear 211, second gear 212, third gear 213 and fourth gear 214). The first gear 211 is engaged with the second gear 212. The second gear 212 is at a same axis with the third gear 213. The third gear 213 is engaged with the fourth gear 214. And, an input shaft 215 is installed at the axle center of the first gear 211 and a rotating disk 217 is fixed at the top end of the input shaft 215. An output shaft 216 is installed at the axle center of the fourth gear 214. An eccentric wheel is fixed at the bottom end of the output shaft and the center of the eccentric wheel 218 is connected to the output shaft 216. Moreover, a rectangular notch 2181 is opened at the circumference of the eccentric wheel 218 and the axle centers of the elements mentioned above are pivotally connected on a base seat 219 to form a gear train module.

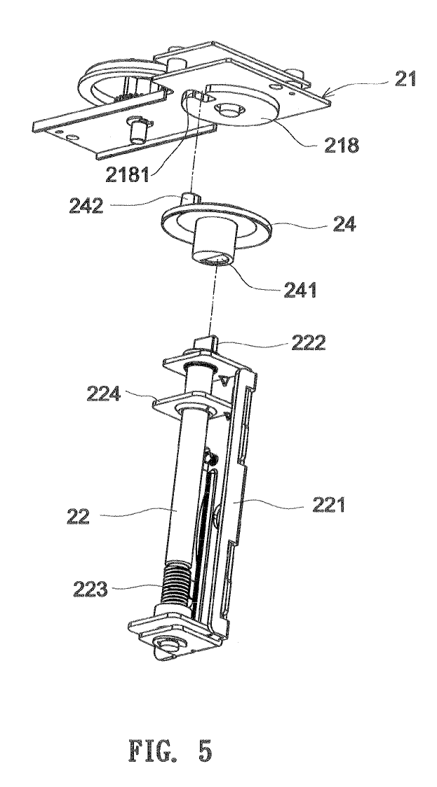

Please refer to FIG. 5. The adjusting shaft 22 is installed below the gear train 21 and erected parallel to a screen (not shown in the figure). And, the two ends of the adjusting shaft 22 are pivotally connected onto a fixed seat 221, and one end thereof is extended out of the fixed seat 221. Moreover, a semi-circular pin 222 is disposed at the extended end. A connector body 24 is installed between the adjusting shaft 22 and the gear train 21. The connector body 24 is a circular disk and a semi-circular slot 241 for accepting the pin 222 is disposed at the center thereof so as to connect the connector body 24 and the adjusting shaft 22. And, an eccentric pin 242 is protruded at the circumference of the connector body 24 and the eccentric pin 242 is accepted in a notch 2181 opened in the eccentric wheel 218 so as to connect the adjusting shaft 22 with the gear train. Furthermore, a gap is existed between the eccentric pin 242 and the notch 2181. After the connector 24 is fixed to the adjusting shaft 22, the eccentric pin 242 is then placed in the notch 2181 to connect the adjusting shaft 22 and the gear train 21. The assembly tolerance is absorbed by the gap between the eccentric pin 242 and the notch 2181. Because an accurate alignment is necessary between the light valve 3 and the projection lens set 23, the manufacturing tolerance of the projection lens 23 set is caused to accumulate on the shifting apparatus. This manufacturing tolerance causes the difficulty on the assembly of the projection lens set. However, the manufacturing tolerance is absorbed through the gap between the eccentric pin 242 and the notch 2181 by using the shifting apparatus 20 according to the present invention so that the assembly difficulty can be improved, the assembly time can be reduced and the production efficiency can be enhanced.

Finally, please refer to FIG. 3. The projection lens set 23 is connected to the adjusting shaft 22 to allow the projection lens set 23 to be able to move relative to the adjusting shaft 22. A screwed section 223 is disposed on the adjusting shaft 22 for connecting the projection lens set 23 with the adjusting shaft 22. And, one end of a U-type sliding seat 224 is screwed to the screwed section 223 and another end thereof is sleeved around the adjusting shaft 22. In addition, a locking element 2241 is disposed at the flank face of the U-type sliding seat 224 for locking the projection lens set 23 therein so as to cause the projection lens set 23 and sliding seat 223 to be combined into one body.

Power is input to the gear train 21 by rotating disk 217 and is then transmitted through the first gear 211, the second gear 212, the third gear 213 and the fourth gear 214 that are engaged with each other to drive the output shaft 216 to rotate. In the meantime, the eccentric wheel 218 on the output shaft 216 is caused to rotate and the eccentric pin 242 is pushed by the rim of the notch 2181 of the eccentric wheel 218 to drive the adjusting shaft 22 to rotate so as to cause the sliding seat 224 to drive the projection lens set 23 to moved along the adjusting shaft 22 up and down to allow the formed image of the projection lens set 23 to be moved parallel to a screen (not shown in the figure) and so as to change an image projecting location on the screen. Comparing with the conventional way that the projection lens set is unmoved and the elevating legs are adjusted, the way provided in the present invention does not cause an image to be projection obliquely so that the deformation of the image can be avoided.

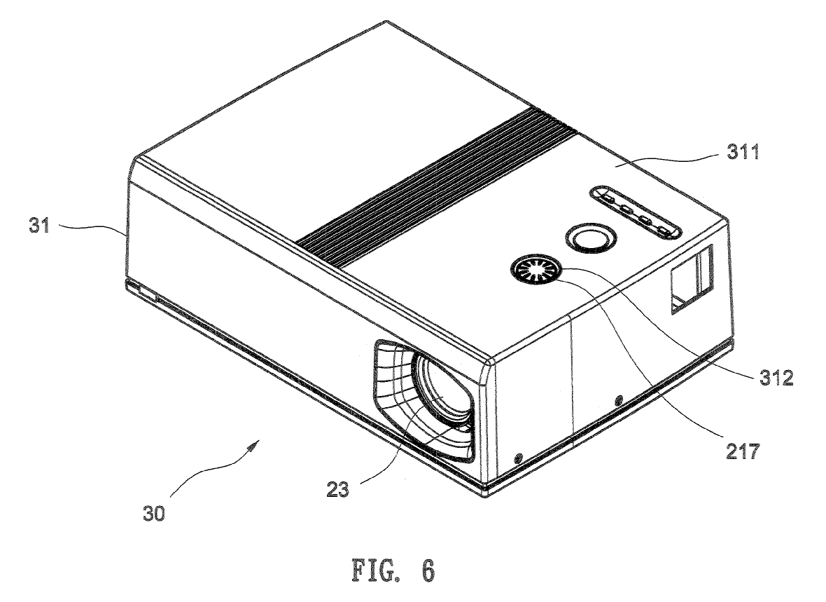

Please refer to FIG. 6. When the projection lens set shifting apparatus 20 according to the present invention is assembled into the projection apparatus 30, the gear train 21 thereof is locked inside of the ceiling plate 311 of the housing 31. A hole 312 is opened in the ceiling plate 311 to accept the rotating disk 216 for being convenient in manual adjustment. One end of the adjusting shaft 22 is fixed to the housing 31 and another end thereof is accepted in the notch 2181. The assembly procedure according to the present invention is to assemble respectively the gear train 21 and the adjusting shaft 22 installed with the projection lens set 23 first into modules. And, the combination of the pin 242 and the notch 2181 is then used to attain to the convenient assembly of the projection lens set shifting apparatus 20 and the assembly tolerance absorption by utilizing the gap between the pin 242 and the notch 2181.

Besides, because the adjusting shaft 22 for driving the projection lens set 23 is driven by the non-coaxial gear train 21, the location of the input shaft 215 is allowed to dispose arbitrarily through the arrangement of gears and not limited by the location of the projection lens set 21. Therefore, the rotating disk 216 of the shifting apparatus 20 is easy to be disposed to comply with the outlook design of the projection apparatus.

Furthermore, the adoption of the reduction gear train with a proper disposing gear ratio can allow the output end (i.e. rotating shaft end) to yield a speed reduction effect. For example, if the speed reduction ratio of the gear train is N:1, i.e. the input shaft 215 is rotated one circle and the output shaft is rotated only 1/N circle so that the force exerted on the input shaft 215 is only 1/N times of the force exerted on the output shaft 216. Therefore, the rotating disk 217 is rotated with only a little force and the output shaft 216 can then be fine adjusted.

It is noted that the projection lens set shifting apparatus described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A projection lens set shifting apparatus, comprising:
a gear train, having an output shaft, said output shaft being connected to an eccentric wheel, a notch being opened at the circumference of said eccentric wheel;
an adjusting shaft, an eccentric pin being disposed at one end thereof, said eccentric pin being accepted in said notch to allow said adjusting shaft and said gear train to be combined together; and
a projection lens set, connected to said adjusting shaft to be allowed to move with said adjusting shaft relatively.

2. The projection lens set shifting apparatus according to claim 1, wherein said gear train is a reduction gear train.

3. The projection lens set shifting apparatus according to claim 2, wherein said gear train is composed of a plurality of spur gears.

4. The projection lens set shifting apparatus according to claim 1, wherein a gap exists between said notch and said eccentric pin.

5. The projection lens set shifting apparatus according to claim 1, wherein said adjusting shaft is parallel to a screen.

6. The projection lens set shifting apparatus according to claim 1, wherein a screwed section is disposed at one end of said adjusting shaft, and a sliding seat is screwed thereon, a locking element is disposed on said sliding seat, said projection lens set is locked with said locking element.

7. The projection lens set shifting apparatus according to claim 1, wherein said gear train further comprises an input shaft, the location of said input shaft is disposed through the arrangement of gears.
